(19) United States
(12) Patent Application Publication
(10) Pub. No.: US 2026/0133164 A1
(43) Pub. Date: May 14, 2026

(54) SCANNING ACOUSTIC MICROSCOPE APPARATUS AND OPERATING SYSTEM AND PLATFORM THEREOF

(71) Applicant: HIGHLIGHT TECH CORP., Tainan City (TW)

(72) Inventors: CHE-FU LIU, Tainan City (TW); JUIN-LIN WANG, Tainan City (TW); HSUAN-YU LIN, Tainan City (TW); MIN-SIOU GU, Tainan City (TW)

(73) Assignee: HIGHLIGHT TECH CORP., Tainan City (TW)

(21) Appl. No.: 19/387,939

(22) Filed: Nov. 13, 2025

Related U.S. Application Data
(60) Provisional application No. 63/788,759, filed on Apr. 14, 2025.

(30) Foreign Application Priority Data
Nov. 14, 2024 (TW) 113143793

(51) Int. Cl. G01N 29/06; G01N 29/265; G01N 29/28; G01N 29/32

(52) U.S. Cl. CPC G01N 29/0681; G01N 29/265; G01N 29/28; G01N 29/32

(57) ABSTRACT

A scanning acoustic microscope (SAM) apparatus and an operating system and platform thereof are provided. The SAM apparatus includes a platform for carrying at least one workpiece, a SAM having a detection probe, and at least one isolation element for causing an isolation state between the workpiece and a detection liquid. The operating system includes a control element configured to receive or formulate a custom path and drive the detection probe to scan according to the custom path. The platform includes a placing stage and a base defining a chamber therebetween. The detection liquid flows through the chamber to generate a negative pressure at the placing stage, thereby forming a suction force to adsorb the workpiece. The SAM apparatus provides ultrasonic waves via the detection probe that penetrate the detection liquid and the isolation element attached to the workpiece, thereby performing an ultrasonic scanning detection procedure on the workpiece.

### CROSS-REFERENCE TO RELATED APPLICATION

This application claims priority to U.S. Provisional Patent Application No. 63/788,759 , filed on Apr. 14, 2025; claims priority from Taiwan Patent Application No. 113143793, filed on Nov. 14, 2024, each of which is hereby incorporated herein by reference in its entirety.

### BACKGROUND OF THE DISCLOSURE

### 1. Field of Disclosure

The present disclosure relates to a scanning acoustic microscope (SAM) apparatus and an operating system and platform thereof.

### 2. Related Art

Ultrasonic waves are transmitted through media capable of conducting sound waves. When ultrasonic waves encounter an interface between media of different densities, a portion of the energy is reflected back. These reflected sound wave energies are then received by a detection probe (Inspection Probe), converted into electrical signals, and subsequently transformed into images displayed on a screen. Traditional ultrasonic scanning technologies all use water as the medium for transmitting sound waves, and it is necessary to immerse the workpiece (e.g., electronic components) and the detection probe in a detection liquid to maintain a certain distance between the detection probe and the workpiece while performing the ultrasonic scanning detection procedure. However, many electronic components are not suitable for contact with water. Regardless of whether the electronic components are suitable for contact with water, a drying process, which is time-consuming or carries a high risk of thermal damage, must be performed after the ultrasonic scanning detection procedure.

Secondly, in conventional ultrasonic scanning detection procedures, the workpiece is usually merely placed on a platform or fixed using mechanical clamps. However, when the workpiece (such as a thin wafer or substrate) is immersed in the detection liquid, simply placing it on the platform may cause the workpiece to shift or float due to liquid disturbance. If mechanical clamps are used for fixation, uneven stress may be applied to the workpiece, leading to deformation or warpage, and the clamps themselves may obscure parts of the detection area, limiting the completeness of the scan. Therefore, how to provide a stable, uniform fixation method in a liquid environment that does not obscure the workpiece is currently one of the problems that remain to be solved.

Furthermore, most conventional scanning acoustic microscopes employ standard X-Y axis scanning paths to perform comprehensive detection on the workpiece. Such fixed scanning paths lack flexibility, which is not only inefficient when only specific areas need to be detected (such as circular wafers or specific square areas) but also completely unable to effectively deal with workpiece having non-flat surfaces or curved structures. When scanning a curved surface, a fixed scanning plane causes the focal length between the detection probe and the surface of the workpiece to constantly change, resulting in most of the scanned images being out of focus and failing to obtain valid detection results

If a person skilled in the art attempts to use a pump underwater to generate suction, they will face a critical problem: when the workpiece (such as a flat wafer) completely covers the suction inlet of the pump's fluid channel, it will cause the fluid channel to be blocked, making the pump unable to draw enough fluid, thereby creating a risk of dry running, which severely damages the pump's lifespan. Therefore, how to use a pump to provide suction while ensuring that the pump always has sufficient fluid passing through is a technical problem that urgently needs to be solved.

### SUMMARY OF THE DISCLOSURE

The present disclosure provides a scanning acoustic microscope (SAM) apparatus, comprising: a platform for carrying at least one workpiece; a scanning acoustic microscope having a detection probe; and at least one isolation element for causing an isolation state between the workpiece and a detection liquid, wherein the scanning acoustic microscope provides ultrasonic waves through the detection probe that penetrate the detection liquid and the isolation element attached to the workpiece, thereby performing an ultrasonic scanning detection procedure on the workpiece on the platform.

Another aspect of the present disclosure is to provide an operating system for a scanning acoustic microscope, for operating a scanning acoustic microscope having a detection probe. The operating system comprises: a control element configured to: (a) receive or formulate a custom path, the custom path comprising a motion trajectory and a detection timing; and (b) generate a control signal and transmit the control signal to the scanning acoustic microscope to drive the detection probe to perform an ultrasonic scanning detection procedure on a workpiece according to the custom path.

Another aspect of the present disclosure is to provide a platform, comprising: a placing stage having a carrying surface for carrying a workpiece, wherein the placing stage is provided with at least one fluid channel penetrating the carrying surface; and a base, wherein a chamber is formed between the base and the placing stage, the base is provided with at least one inlet and at least one outlet communicating with the chamber, wherein a detection liquid flows from the inlet of the base through the chamber and flows out from the outlet of the base to form a continuous flow in the chamber, thereby generating a negative pressure at the fluid channel of the placing stage, and forming a suction force for adsorbing the workpiece by the negative pressure.

To further understand and recognize the technical features and the achieved technical effects of the present disclosure, detailed descriptions are provided below in conjunction with preferred embodiments and accompanying drawings.

### BRIEF DESCRIPTION OF THE DRAWINGS

FIG. 1 is a schematic diagram illustrating the operation of a scanning acoustic microscope apparatus of the present disclosure using an isolation element to prevent a workpiece from contacting a detection liquid, wherein the scanning acoustic microscope employs a reflection-type detection technique.

FIG. 2 is a schematic diagram illustrating the operation of the scanning acoustic microscope apparatus of the present disclosure using an isolation element to prevent the workpiece from contacting the detection liquid, wherein the scanning acoustic microscope employs a transmission-type detection technique.

FIG. 3 is a schematic operational diagram of the scanning acoustic microscope apparatus of the present disclosure performing an ultrasonic scanning detection procedure in a processing tank.

FIG. 4 is a schematic cross-sectional diagram of the scanning acoustic microscope apparatus of the present disclosure with an isolation element wrapping the workpiece.

FIG. 5 is a schematic cross-sectional diagram of the scanning acoustic microscope apparatus of the present disclosure with an isolation element fixedly wrapping a detection probe.

FIG. 6 is a schematic cross-sectional diagram of the scanning acoustic microscope apparatus of the present disclosure with an isolation element expandably wrapping a detection probe.

FIG. 7 is a schematic cross-sectional diagram of the scanning acoustic microscope apparatus of the present disclosure with an isolation element wrapping a detection liquid.

FIG. 8 is a schematic cross-sectional diagram of the scanning acoustic microscope apparatus of the present disclosure having an adjustment device, wherein the adjustment device hangs on a processing tank.

FIG. 9 is a schematic cross-sectional diagram of the scanning acoustic microscope apparatus of the present disclosure having an adjustment device, wherein the adjustment device raises the platform from the bottom of a processing tank.

FIG. 10 is a top view schematic diagram of the scanning acoustic microscope apparatus of the present disclosure having adjustment devices, wherein only the platform, the workpiece, and the adjustment devices are shown to simplify the illustration.

FIG. 11 is a schematic cross-sectional diagram of the platform of the scanning acoustic microscope apparatus of the present disclosure comprising a plurality of combined expansion stages.

FIG. 12 is a top view schematic diagram of the platform of the scanning acoustic microscope apparatus of the present disclosure comprising a plurality of combined expansion stages, wherein only a part of the structure is shown to simplify the illustration.

FIG. 13 is a schematic cross-sectional diagram of the scanning acoustic microscope apparatus of the present disclosure having optical sensing devices, wherein the position of the workpiece is above the liquid surface.

FIG. 14 is a schematic cross-sectional diagram of the scanning acoustic microscope apparatus of the present disclosure having optical sensing devices, wherein the position of the workpiece is moved below the liquid surface.

FIG. 15 is a schematic diagram of the scanning acoustic microscope apparatus of the present disclosure having an operating system and a multi-axis drive mechanism.

FIG. 16 is a functional block diagram of a preferred embodiment of the operating system of the present disclosure.

FIG. 17 is a flow chart of scan mode selection of a programmable logic controller (PLC) of the present disclosure.

FIG. 18 is a schematic diagram of an embodiment (serpentine path) of a custom path of the present disclosure.

FIG. 19 is a schematic diagram of a detection probe scanning a curved surface according to a four-axis motion path of the present disclosure.

FIG. 20 is a schematic diagram of a detection probe performing detection in a stamp method (step-and-repeat) according to the present disclosure.

FIG. 21 is a schematic perspective assembly diagram of a fluid-flow type adsorption platform of the present disclosure, viewed from the top.

FIG. 22 is a schematic perspective assembly diagram of a fluid-flow type adsorption platform of the present disclosure, viewed from the bottom.

FIG. 23 is a schematic perspective exploded diagram of the fluid-flow type adsorption platform of the present disclosure.

FIG. 24 is a schematic cross-sectional diagram of the fluid-flow type adsorption platform of the present disclosure operating in a detection liquid.

FIG. 25 is a top view schematic diagram of the fluid-flow type adsorption platform of the present disclosure having blocking pieces.

FIG. 26 is a schematic perspective exploded diagram of another embodiment of the fluid-flow type adsorption platform of the present disclosure.

FIG. 27 is a schematic diagram of a piping configuration of the platform of the present disclosure having a regulation device.

FIG. 28 is a schematic diagram of a piping configuration of the regulation device of the platform of the present disclosure having a water exchange function.

FIG. 29 is a schematic diagram of a piping configuration of the regulation device of the platform of the present disclosure having a zoned adsorption control function.

### DETAILED DESCRIPTION OF THE DISCLOSURE

In order to understand the technical features, content and advantages of the disclosure and its achievable efficacies, the disclosure is described below in detail in conjunction with the figures, and in the form of embodiments, the figures used herein are only for a purpose of schematically supplementing the specification, and may not be true proportions and precise configurations after implementation of the disclosure; and therefore, relationship between the proportions and configurations of the attached figures should not be interpreted to limit the scope of the claims of the disclosure in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present disclosure will be defined below or in other parts of the descriptions as an extra guidance for those skilled in the art to understand the descriptions of the present disclosure.

The terms such as “first”, “second”, “third” and “fourth” used in the descriptions are not indicating an order or sequence, and are not intending to limit the scope of the present disclosure. They are used only for differentiation of components or operations described by the same terms. Moreover, the terms “comprising”, “including”, “having”, and “with” used in the descriptions are all open terms and have the meaning of “comprising but not limited to”.

The present disclosure provides a Scanning Acoustic Microscope (SAM) apparatus that uses an isolation element with a waterproof effect to create an isolation effect (or barrier effect) between a workpiece (e.g., an electronic component) and a detection liquid (e.g., water). The isolation element selected in the present disclosure has a low acoustic impedance difference with water, and the isolation element does not block the penetration of ultrasonic signals. Therefore, it could effectively reduce the adverse effects of using the isolation element on the ultrasonic scanning detection procedure, avoid the problem that electronic components are not suitable for contacting the detection liquid, and also avoid the problem of performing drying processes that are time-consuming or have a high risk of thermal damage. The isolation element of the present disclosure could use various methods to keep a measurement area of the workpiece from contacting the detection liquid during the ultrasonic scanning detection procedure, such as wrapping the workpiece, the detection probe, and/or the detection liquid with the isolation element, so that the workpiece is isolated from the detection liquid, for example, at least keeping the measurement area of the workpiece from contacting the detection liquid during the ultrasonic scanning detection procedure.

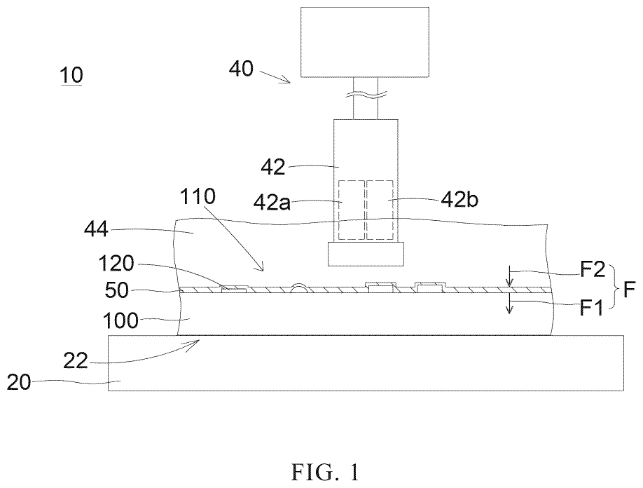

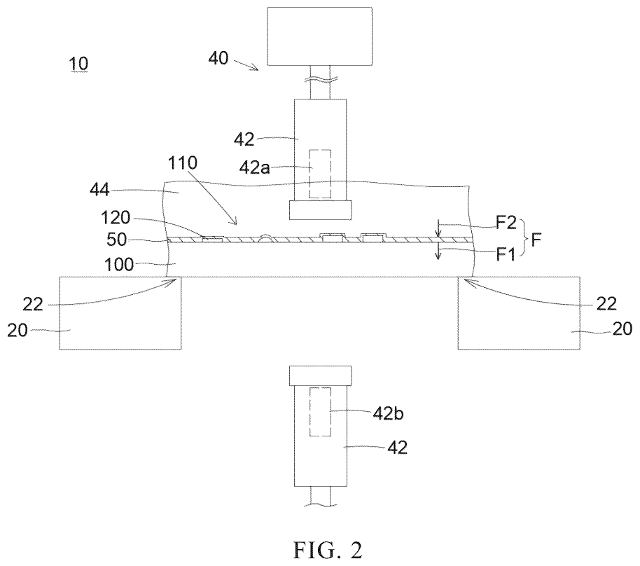

Please refer to FIG. 1 to FIG. 14. FIG. 1 is a schematic diagram illustrating the operation of a scanning acoustic microscope apparatus of the present disclosure using an isolation element to prevent a workpiece from contacting a detection liquid, wherein the scanning acoustic microscope employs a reflection-type detection technique. FIG. 2 is a schematic diagram illustrating the operation of the scanning acoustic microscope apparatus of the present disclosure using an isolation element to prevent the workpiece from contacting the detection liquid, wherein the scanning acoustic microscope employs a transmission-type detection technique. The scanning acoustic microscope apparatus 10 of the present disclosure comprises a platform 20, a scanning acoustic microscope 40, and at least one isolation element 50. The platform 20 is used for carrying at least one workpiece 100. The isolation element 50 is used for preventing a detection liquid 44 from contacting the workpiece 100. The scanning acoustic microscope 40 has a detection probe 42, and the scanning acoustic microscope 40 is used to provide ultrasonic waves and/or receive ultrasonic waves via the detection probe 42, thereby performing an ultrasonic scanning detection procedure on the workpiece 100. The detection probe 42 comprises an ultrasonic transmitter 42a and an ultrasonic receiver 42b. The ultrasonic transmitter 42a is used to output ultrasonic waves, and the ultrasonic receiver 42b is used to receive ultrasonic waves. The ultrasonic transmitter 42a and the ultrasonic receiver 42b of the present disclosure are not limited to specific relative positions; they could be located on the same side of the workpiece 100 (as integrated into the detection probe 42 exemplified in FIG. 1) or on different sides (as separately located in detection probes 42 exemplified in FIG. 2). As long as they could be used to perform the ultrasonic scanning detection procedure of the present disclosure, any corresponding adjustments to the structure or position of the scanning acoustic microscope apparatus and its components fall within the scope of protection of the present disclosure. Moreover, to avoid complicating the description of the embodiments of the present disclosure, only the example where the ultrasonic transmitter 42a and the ultrasonic receiver 42b are located on the same side of the workpiece 100 is used for illustration. The present disclosure could employ various conventional scanning acoustic microscopes 40 to perform ultrasonic scanning detection procedures using various conventional ultrasonic scanning detection principles, and their structures and operation methods are well known to those of ordinary skill in the art to which the present disclosure pertains, so they will not be detailed here. In one embodiment, the detection probe 42 could also be designed as a modular probe with possibilities for expansion or extension, for example, allowing replacement of probe modules with different frequencies or focal lengths; alternatively, the probe could be a broadband (or multi-frequency) design, where a single probe could be suitable for different frequencies to adapt to different detection needs.

The platform 20 of the scanning acoustic microscope apparatus 10 of the present disclosure comprises, for example, at least one placing stage 22, whereby the workpiece 100 could be placed on the placing stage 22 of the platform 20. The placing stage 22 could be, for example, built-in or externally attached to the platform 20, or an area could even be defined on the platform 20 as the placing stage 22. The platform 20 is not limited to a fixed platform or a movable platform. A movable platform is, for example, a carrying platform with functions such as lifting, turning, translation, tilt adjustment, flatness adjustment, and/or straightness adjustment. Moreover, the platform 20 is not limited to carrying the workpiece 100 in a fixed or movable manner. Although the present disclosure proposes a fluid-flow type adsorption platform to improve the shortcomings of traditional platforms, the present disclosure is not limited thereto. Any platform design capable of carrying the workpiece 100, such as conventional techniques of placing the workpiece 100 on the platform or using mechanical clamps for fixation, could be applied to the scanning acoustic microscope apparatus 10 and its operation method of the present disclosure.

One feature of the present disclosure lies in having the isolation element 50 to cause an isolation state between the workpiece 100 and the detection liquid 44, thereby avoiding contact of all or part of the area of the workpiece 100 with the detection liquid 44. Therefore, it could prevent the workpiece 100 from contacting the detection liquid 44 (e.g., liquid or moisture) and could save the time for drying treatment of the workpiece 100. The number of workpieces 100 and isolation elements 50 could each be one or plural, and are not limited to being identical in number corresponding to each other; the numbers of workpieces 100 and isolation elements 50 could also be different from each other. In the ultrasonic scanning detection procedure, the scanning acoustic microscope 40 provides ultrasonic waves via the detection probe (Inspection Probe) 42 that penetrate the detection liquid 44 and the isolation element 50 attached (or covered) on the workpiece 100, thereby performing the ultrasonic scanning detection procedure on the workpiece 100 carried by the platform 20. Subsequently, by performing signal processing on the detection signals obtained from the ultrasonic scanning detection procedure, and by separating (or filtering) the signals of the isolation element 50, the measurement results of the workpiece 100 could be obtained. Therefore, the isolation element 50 of the present disclosure substantially does not affect the operation of the ultrasonic scanning detection procedure, and does not affect the detection probe 42 in providing and/or receiving ultrasonic waves. In order to avoid reducing reflection and refraction phenomena of ultrasonic waves at the interface between the isolation element 50 and the detection liquid 44, which would affect characteristics such as propagation, absorption, reflection, and penetration of ultrasonic waves, the acoustic impedance of the isolation element 50 is preferably approximately equal to or the same as the acoustic impedance of the detection liquid 44. For example, if the detection liquid 44 is water, and the acoustic impedance of water is about 1.5 MRayl, then the acoustic impedance of the isolation element 50 is preferably approximately equal to or the same as 1.5 MRayl, and the closer the better, wherein the acoustic impedance of the isolation element 50 is from about 1.5 MRayl to about 3.5 MRayl. The detection liquid 44 used in the present disclosure is not limited to traditional water, and could optionally be changed to use a liquid component whose acoustic impedance is close to or the same as that of the selected isolation element 50, such as an aqueous solution or other liquids. Furthermore, the difference between the acoustic impedance of the isolation element 50 and the acoustic impedance of the detection liquid 44 could be applied to the present disclosure as long as it does not affect the operation of the ultrasonic scanning detection procedure, and is not limited to being approximately equal to or the same as each other.

In order to avoid ultrasonic signal interference, energy loss due to sound energy absorption, and interference from extra media (such as air), the higher the degree of tightness (i.e., degree of conformity) between the isolation element 50 and components 120 (e.g., electronic components) on the workpiece 100, the better. This is because a higher degree of tightness means that the gap between the isolation element 50 and the workpiece 100 will be smaller or even disappear, so the adverse effect of the isolation element 50 on the ultrasonic scanning detection procedure will also be smaller. The isolation element 50 preferably (but is not limited to) has a deformable structure, and partly or wholly is a deformable structure. The material of the isolation element 50 is, for example (but not limited to), an elastic material and/or a stretchable material, and the thinner the thickness of the isolation element 50, the better, so that the isolation element 50 could closely or conformally attach to the workpiece 100 after being acted upon by an external force F (e.g., suction force F1 or pushing force F2). For example, the isolation element 50 is, for instance, a film-like structure, preferably a thin film. The thickness of the isolation element 50 is, for example (but not limited to), less than or equal to about 100 μm, and the thinner the better. The thinner the thickness of the isolation element 50 and the better the elastic and/or stretchable material, the more it could enhance the attachment effect and reduce signal noise and energy absorption loss. For example, the material of the isolation element 50 is, for instance, selected from the group consisting of polymers composed of silicone, rubber, plastic, and composite high-polymer polymers. However, as long as there is no concern that the workpiece 100 will contact the detection liquid 44, for example, if the flatness of the surface (e.g., flat surface) of the workpiece 100 is sufficient so that the isolation element 50 attached thereto could provide an isolation effect, then the material of the isolation element 50 of the present disclosure is not limited to using elastic materials and/or stretchable materials; it could be various suitable materials, as long as they could exert an isolation effect, they could be applied in the present disclosure. In addition, the isolation element 50 is not limited to a single-layer film structure; it could optionally be a multi-layer film structure, and the materials of each film layer in the multi-layer film structure could be the same or different. Moreover, the isolation element 50 is not limited to a specific shape; it could be selectively determined according to the shape of the workpiece 100 to which it is to be attached. Furthermore, if the isolation element 50 has elastic properties or tensile properties, its shape could be changed according to the shape of the workpiece 100.

The isolation element 50 of the present disclosure can, for example, isolate the workpiece 100 from the detection liquid 44 by wrapping the workpiece 100, the detection probe 42, and/or the detection liquid 44, that is, at least enabling a measurement area 110 of the workpiece 100 to remain out of contact with the detection liquid 44 during the ultrasonic scanning detection procedure. In short, the purpose of the present disclosure is to cause a partial area or the entire area of the workpiece 100 not to contact the detection liquid 44, so it is necessary to place said partial or entire area of the workpiece 100 in a non-liquid environment (i.e., not contacting the detection liquid 44). As for the scanning acoustic microscope 40, it is not restricted; the detection probe 42 of the scanning acoustic microscope 40 could be in a liquid environment or in a non-liquid environment. The platform 20, scanning acoustic microscope 40, and isolation element 50 of the present disclosure are not limited to specific configurations or specific operation methods; they could be correspondingly adjusted in configuration or operation method according to the actual needs of the scanning acoustic microscope apparatus 10 performing the ultrasonic scanning detection procedure.

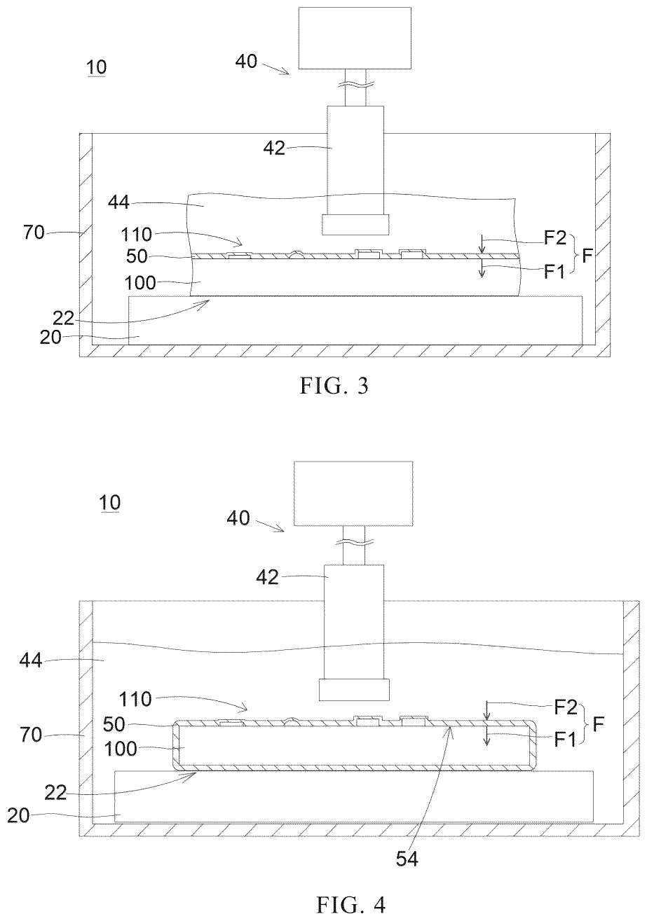

Please refer to FIG. 3 and other drawings together. FIG. 3 is a schematic operational diagram of the scanning acoustic microscope apparatus 10 of the present disclosure performing an ultrasonic scanning detection procedure in a processing tank 70. The scanning acoustic microscope apparatus 10 of the present disclosure may optionally further comprise a processing tank 70 for containing the detection liquid 44 to provide a liquid environment, and the structure shown in FIG. 1 could be placed into the processing tank 70 to perform the ultrasonic scanning detection procedure in the liquid environment provided by the processing tank 70. However, the present disclosure is not limited thereto. The present disclosure could also optionally omit the processing tank 70, as long as the detection liquid 44 could provide the liquid environment required for the scanning acoustic microscope 40 to perform the ultrasonic scanning detection procedure on the workpiece 100, it could be applied to the present disclosure.

Please refer to FIG. 4 and other drawings together. FIG. 4 is a schematic cross-sectional diagram of the scanning acoustic microscope apparatus 10 of the present disclosure employing an isolation element 50 to wrap the workpiece 100. In a first embodiment, the present disclosure uses the isolation element 50 to wrap the workpiece 100 to prevent the workpiece 100 from contacting the detection liquid 44, wherein the workpiece 100 is located in a non-liquid environment (i.e., not contacting the detection liquid 44), and the detection probe 42 of the scanning acoustic microscope 40 is located in the liquid environment provided by the detection liquid 44.

For example, the isolation element 50 is, for instance, a bag body, which serves as a protective bag for wrapping part or all of the workpiece 100 inside the bag body, wherein an inner surface 54 of the bag body is attached to the workpiece 100, thus enabling the workpiece 100 to be located in a non-liquid environment (i.e., not contacting the detection liquid 44).

In the first embodiment, the detection liquid 44 is, for example, located in the processing tank 70 to provide a liquid environment. In the ultrasonic scanning detection procedure, the workpiece 100 is immersed in the detection liquid 44 in the processing tank 70 under the protection of the isolation element 50, so that an isolation state is presented between the workpiece 100 and the detection liquid 44. In addition, the detection probe 42 of the scanning acoustic microscope 40 is immersed in the detection liquid 44 in the processing tank 70 and is located outside the isolation element 50 at a certain distance. This distance is not limited to a specific value and depends on the actual operation of the ultrasonic scanning detection procedure. Thereby, the scanning acoustic microscope 40 could provide ultrasonic waves via the detection probe 42 that penetrate the detection liquid 44 and the isolation element 50 attached to the workpiece 100, and receive ultrasonic waves, thereby performing the ultrasonic scanning detection procedure on the workpiece 100 on the platform 20.

The present disclosure could also optionally use an external force F to cause the inner surface 54 of the isolation element 50 to attach more closely to the entire area or at least a partial area of the workpiece 100, for example, attaching to the entire workpiece 100 or attaching to a part of the workpiece 100 (e.g., the measurement area 110). The external force F could be, for example, a one-time or continuous suction force, pushing force, and/or other types of forces. The scanning acoustic microscope apparatus 10 of the present disclosure could optionally use an external force supply source (not shown) to provide the aforementioned external force F. For example, the external force supply source could be an air extraction device for providing a suction force F1 as the external force. The air extraction device extracts gas (such as air) between the isolation element 50 and the workpiece 100, causing the isolation element 50 to attach (e.g., closely or conformally attach) to the measurement area 110 of the workpiece 100. Taking vacuum attachment of the isolation element 50 to the workpiece 100 as an example, the present disclosure could optionally wrap the workpiece 100 with the isolation element 50 before immersing the workpiece 100 in the detection liquid 44, and for example, use an air extraction device to extract gas between the isolation element 50 and the workpiece 100, so that the isolation element 50 is vacuum-adsorbed on the surface of the workpiece 100, and then immerse the workpiece 100 wrapped with the isolation element 50 into the detection liquid 44 for performing the ultrasonic scanning detection procedure. In addition, the external force supply source could also be a pushing force source for providing a pushing force F2 and applying pressure on the workpiece 100, wherein the pushing force source could be any object capable of applying pressure once or continuously, such as a pushing element. By applying pressure, the gas between the isolation element 50 and the workpiece 100 could be expelled, making the isolation element 50 closely or conformally attached to the workpiece 100. In other words, since the detection liquid 44 could apply liquid weight on the workpiece 100, the detection liquid 44 also belongs to a kind of pushing force source.

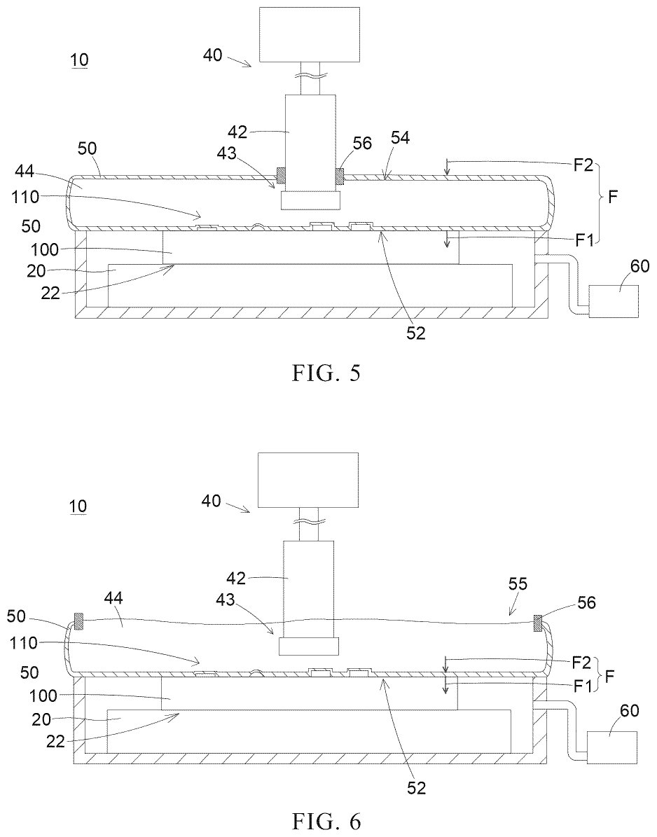

Please refer to FIG. 5 and FIG. 6 and other drawings together. FIG. 5 is a schematic cross-sectional diagram of the scanning acoustic microscope apparatus 10 of the present disclosure employing an isolation element 50 to fixedly wrap the detection probe 42. FIG. 6 is a schematic cross-sectional diagram of the scanning acoustic microscope apparatus 10 of the present disclosure employing an isolation element 50 to expandably wrap the detection probe 42. In a second embodiment, the present disclosure uses the isolation element 50 to wrap the detection probe 42 to prevent the workpiece 100 from contacting the detection liquid 44, thus enabling the workpiece 100 to be located in a non-liquid environment (e.g., atmospheric environment or gas environment), while the detection probe 42 of the scanning acoustic microscope 40 is located in the liquid environment (e.g., water) provided by the detection liquid 44.

For example, the isolation element 50 is, for instance, a bag body. The detection liquid 44 is filled inside the isolation element 50 to provide a liquid environment, and the detection probe 42 is immersed in the detection liquid 44 within the isolation element 50. The workpiece 100 is located outside the isolation element 50 and in a non-liquid environment (i.e., not contacting the detection liquid 44). The isolation element 50 (bag body) is attached to the workpiece 100 with an outer surface 52. Therefore, in the ultrasonic scanning detection procedure of the second embodiment, the workpiece 100 could also be located in a non-liquid environment.

In the second embodiment, the isolation element 50 is not limited to fixedly or non-fixedly wrapping both the detection probe 42 and the detection liquid 44 simultaneously. For example, the scanning acoustic microscope apparatus 10 further comprises a fixing utensil 56 provided on the isolation element 50. The fixing utensil 56 (e.g., a fixed retaining ring) optionally fixes the isolation element 50 to at least one end portion 43 of the detection probe 42 (as shown in FIG. 5), which is helpful for small-range scanning and facilitates measuring small areas of multiple samples (i.e., multiple workpieces 100). Alternatively, the fixing utensil 56 (e.g., an expandable fixing bracket) could expand the isolation element 50 into a container 55 filled with the detection liquid 44 (as shown in FIG. 6) to provide the aforementioned liquid environment, allowing the detection probe 42 to move within the container 55, which is helpful for large-range scanning and facilitates measuring large areas of a single sample (i.e., a single workpiece 100). Thereby, the scanning acoustic microscope 40 could provide ultrasonic waves via the detection probe 42 that penetrate the detection liquid 44 and the isolation element 50 attached to the workpiece 100, and receive ultrasonic waves, thereby performing the ultrasonic scanning detection procedure on the workpiece 100 on the platform 20.

The present disclosure could also optionally use an external force F to cause the outer surface 52 of the isolation element 50 to attach more closely to the entire area or at least a partial area of the workpiece 100, for example, attaching to the entire workpiece 100 or attaching to a part of the workpiece 100 (e.g., the measurement area 110). The external force F could be, for example, a one-time or continuous suction force, pushing force, and/or other types of forces. The scanning acoustic microscope apparatus 10 of the present disclosure could optionally further comprise an external force supply source 60 for providing the aforementioned external force F. For example, the external force supply source 60 could be an air extraction device for providing a suction force as the external force. The air extraction device extracts gas (such as air) between the isolation element 50 and the workpiece 100, causing the isolation element 50 to attach (e.g., closely or conformally attach) to the measurement area 110 of the workpiece 100. Taking the external force F being a suction force as an example, the present disclosure can, for instance, place the workpiece 100 in an empty processing tank 70, i.e., place the workpiece 100 inside the processing tank 70 not filled with the detection liquid 44, and attach the outer surface 52 of the isolation element 50 to the processing tank 70 and/or the workpiece 100, and then, for example, use an air extraction device to extract gas between the workpiece 100 and the isolation element 50, thereby causing the isolation element 50 to attach (e.g., closely or conformally attach) to the measurement area 110 of the workpiece 100. The external force supply source 60 could also be a pushing force source (e.g., a push rod, or even the detection liquid 44 itself belongs to a kind of pushing force source) for providing a pushing force.

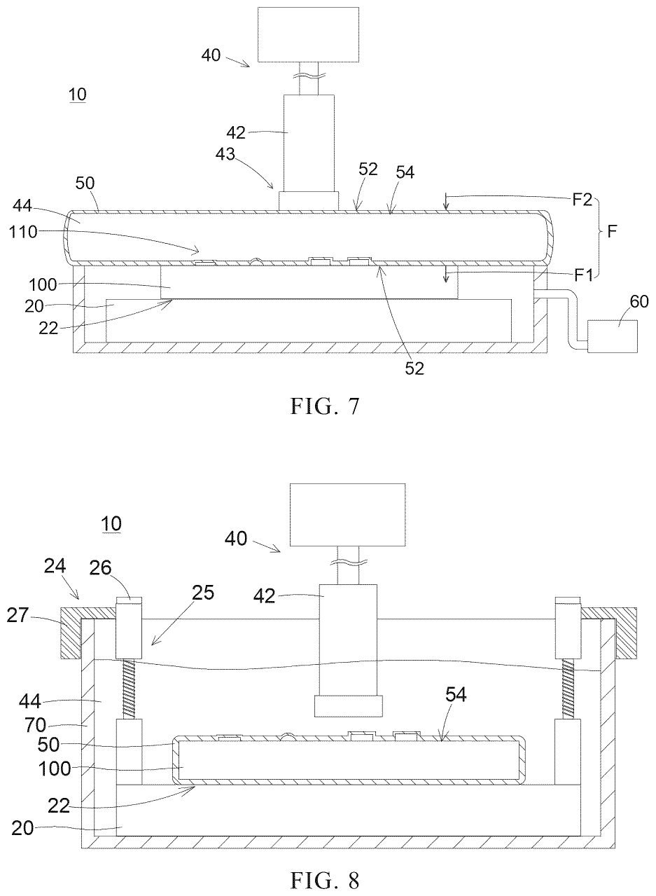

Please refer to FIG. 7 and other drawings together. In a third embodiment, the present disclosure uses the isolation element 50 (e.g., a bag body) to wrap the detection liquid 44 to prevent the workpiece 100 from contacting the detection liquid 44, wherein the workpiece 100 is located in a non-liquid environment (i.e., not contacting the detection liquid 44), and the detection probe 42 of the scanning acoustic microscope 40 is optionally located in a non-liquid environment or a liquid environment. In the ultrasonic scanning detection procedure, the present disclosure could place the isolation element 50 wrapped with the detection liquid 44 on the workpiece 100, and then place the detection probe 42 of the scanning acoustic microscope 40 on the isolation element 50 (bag body). That is, in the third embodiment, the present disclosure causes two opposite outer surfaces 52 of the isolation element 50 (bag body) to be respectively attached to the workpiece 100 and the detection probe 42. Thereby, the scanning acoustic microscope 40 could provide ultrasonic waves via the detection probe 42 that penetrate the detection liquid 44 and the isolation element 50, thereby performing the ultrasonic scanning detection procedure on the workpiece 100 on the platform 20.

Similar to the first embodiment and the second embodiment, the present disclosure could also optionally use an external force F to cause the outer surface 52 of the isolation element 50 to attach more closely to the entire area or at least a partial area of the workpiece 100, for example, attaching to the entire workpiece 100 or attaching to a part of the workpiece 100 (e.g., the measurement area 110). The external force F could be, for example, a one-time or continuous suction force, pushing force, and/or other types of forces. In addition, the present disclosure could also optionally use an external force F to cause the outer surface 52 of the isolation element 50 to conformally attach to the detection probe 42. However, since the detection probe 42 is less afraid of contacting the detection liquid 44, and even if it contacts the detection liquid 44, the interference or influence is quite small, the present disclosure could also optionally provide the detection liquid 44 between the outer surface 52 of the isolation element 50 and the detection probe 42, for example, by dripping the detection liquid 44 between the outer surface 52 of the isolation element 50 and the detection probe 42, or performing the ultrasonic scanning detection procedure in the aforementioned processing tank 70 filled with the detection liquid 44, so that the detection liquid 44 automatically fills between the outer surface 52 of the isolation element 50 and the detection probe 42, which is helpful for measuring small areas of multiple samples (i.e., multiple workpieces 100) or large areas of a single sample (i.e., a single workpiece 100).

Since the workpiece 100 often has undulations and non-perfect horizontal surfaces, when the workpiece 100 has a tilt angle, ultrasonic images beyond the focal range of the detection probe 42 of the scanning acoustic microscope 40 will be out of focus, and when the height difference of the workpiece 100 is greater than the focal range, ultrasonic images will also be out of focus.

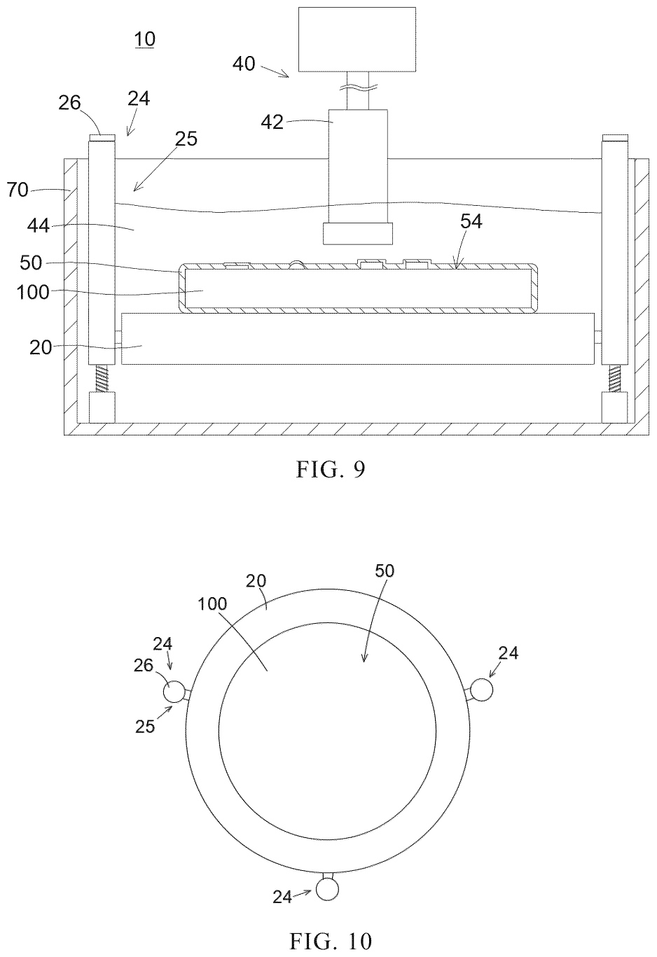

Therefore, taking the platform 20 as a movable platform, such as a carrying platform with functions like lifting, turning, translation, tilt adjustment, flatness adjustment, and/or straightness adjustment, as an example. Please refer to FIG. 8 to FIG. 10 and other drawings together. The platform 20 of the present disclosure could optionally comprise at least one adjustment device 24. The platform 20 could be set at any position via the adjustment device 24, for example, set at the bottom of the processing tank 70 (as shown in FIG. 9) or hung on the processing tank 70 (as shown in FIG. 8), or set on any work table surface. The number of adjustment devices 24 is, for example, one or plural, used for adjusting the height and/or tilt angle of at least one side of the workpiece 100 on the placing stage 22 of the platform 20.

The adjustment device 24 is not limited to manual or electric adjustment elements, and is not limited to manually controlled or electronically controlled electric adjustment elements; it could operate according to manual control or electronic control commands. Moreover, the adjustment device 24 could be, for example, an adjustment element 25 with a single axis or multiple axes, such as a screw-type lifting element. Taking the adjustment device 24 as an electric adjustment element as an example, the adjustment device 24 comprises, for example, at least one control element 26 located on the adjustment element 25, which could operate according to manual control or electronic control commands to control the adjustment device 24 to adjust the height and/or tilt angle of at least one side of the workpiece 100 on the placing stage 22. The adjustment device 24 of the present disclosure is not limited to a specific form of adjustment element 25; it can, for example but not limited to, employ a traditional lifting element combining gears and screws. Depending on whether the control element 26 is operated by manual control or electronic control, the control element 26 could be, for example, a manual drive element (e.g., a turntable) or an electric drive element (e.g., a motor) to drive the gears and screws to rotate, thereby achieving the effect of adjusting the height and/or tilt angle of at least one side of the workpiece 100 on the placing stage 22 of the platform 20.

For example, as shown in FIG. 8, the adjustment device 24 of the present disclosure could optionally have a hook member 27. By means of the hook member 27, the adjustment device 24 and the platform 20 connected and adjusted by it could be hung together in the tank of the processing tank 70, enabling the platform 20 and the workpiece 100 carried by it to perform the aforementioned adjustment actions in the detection liquid 44 in the processing tank 70.

Since the control element 26 needs a higher waterproof rating if it operates while immersed in the detection liquid 44, when performing the ultrasonic scanning detection procedure, if the platform 20 is immersed in the detection liquid 44, in order to avoid the control element 26 contacting the detection liquid 44, the control element 26 is preferably located outside the detection liquid 44 (i.e., above the liquid surface), thereby eliminating the need to increase the waterproof rating requirement. The adjustment device 24 of the present disclosure could hang the platform 20 in the detection liquid 44 of the processing tank 70 via the hook member 27, and make the control element 26 located above the liquid surface of the detection liquid 44 in the processing tank 70, thereby reducing the waterproof rating requirement. Alternatively, the adjustment device 24 of the present disclosure could also be set at the bottom of the processing tank 70 and raise the platform 20 from the bottom of the processing tank 70 to suspend it, wherein the top end of the adjustment device 24 extends to the outside of the liquid surface of the detection liquid 44, so that the control element 26 set on the adjustment device 24 could be located above the liquid surface of the detection liquid 44, thereby reducing the waterproof rating requirement.

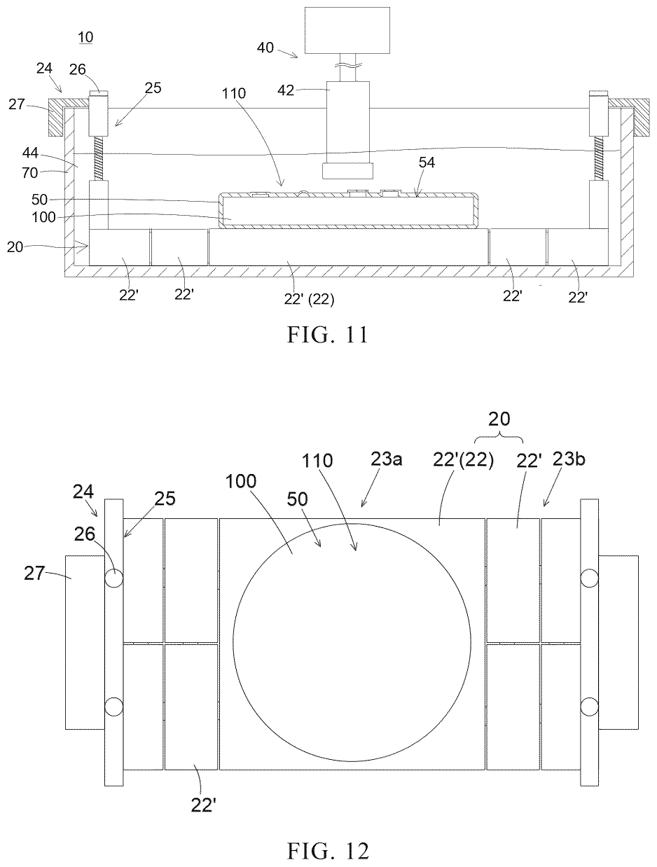

Please refer to FIG. 11 and FIG. 12 and other drawings together. FIG. 11 is a schematic cross-sectional diagram of the platform of the scanning acoustic microscope apparatus of the present disclosure comprising a plurality of combined expansion stages. FIG. 12 is a top view schematic diagram of the platform of the scanning acoustic microscope apparatus of the present disclosure comprising a plurality of combined expansion stages, wherein only a part of the structure is shown to simplify the illustration. Since the sizes of the processing tank 70 (e.g., water tank) and the platform 20 used in various ultrasonic scanning detection procedures are not invariable, and the structure of the scanning acoustic microscope apparatus 10, such as its platform 20 and/or adjustment device 24, is not easily put into the processing tank 70, the platform 20 of the present disclosure could optionally have a spliced design or assembled design, for example comprising a plurality of combined expansion stages 22′ to form the platform 20, and one or plural of these combined expansion stages 22′ constitute the placing stage 22 for placing the workpiece 100. By adjusting the number and size of the combined expansion stages 22′, the present disclosure could make the combined platform 20 adaptable to different sizes of processing tanks 70 (e.g., water tanks).

The present disclosure could also adjust the flatness of the placing stage 22 and the measurement area 110 of the workpiece 100 thereon by adjusting the combined expansion stages 22′ at other positions. Since only the measurement area 110 of the workpiece 100 needs high precision flatness, the present disclosure does not need to make the surfaces of all combined expansion stages 22′constituting the platform 20 have the same high precision flatness. In other words, the flatness of at least one first area 23a of the platform 20 of the present disclosure is better than the flatness of at least one second area 23b, wherein the aforementioned first area 23a corresponds to the placing stage 22 and/or the measurement area 110 of the workpiece 100 set on the placing stage 22.

In addition, during traditional ultrasonic scanning detection procedures, structures such as detection probes need additional positioning systems to help users identify positioning when moving. Moreover, traditionally, when adjusting the height of the platform to achieve zoom functionality, an additional positioning determination system is also needed to realize it.

The present disclosure is based on the technical foundation that optical detection technology is superior in measuring the surface of an object (e.g., workpiece 100), while ultrasonic detection technology is superior in measuring its interior. Therefore, by combining the technologies of an optical sensing device (e.g., a CCD camera) and the scanning acoustic microscope 40 (e.g., detection probe 42), the present disclosure could first perform a surface detection procedure of automated optical inspection (AOI), and use the optical sensing device on the side for observation and positioning, for example, performing image recognition to achieve positioning and anti-collision functions.

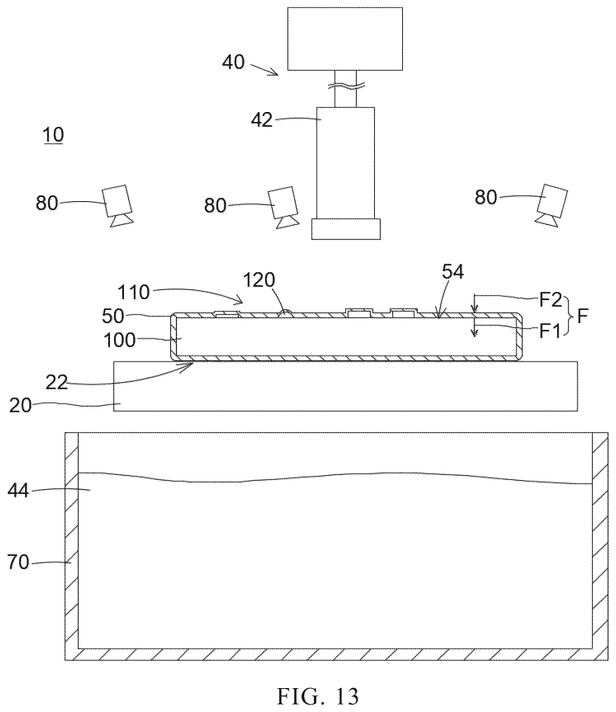

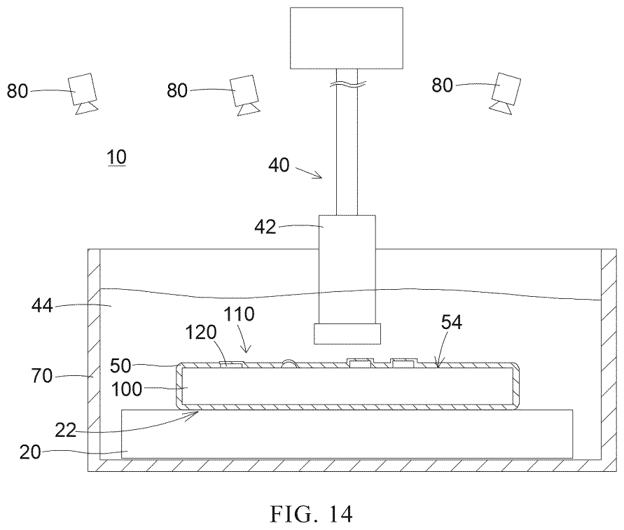

For example, please refer to FIGS. 13 and 14 and other drawings together. FIG. 13 is a schematic cross-sectional diagram of the scanning acoustic microscope apparatus of the present disclosure having optical sensing devices, wherein the position of the workpiece is above the liquid surface. FIG. 14 is a schematic cross-sectional diagram of the scanning acoustic microscope apparatus of the present disclosure having optical sensing devices, wherein the position of the workpiece is moved below the liquid surface. The scanning acoustic microscope apparatus 10 of the present disclosure optionally further comprises at least one optical sensing device 80 for performing an Automated Optical Inspection (AOI) procedure and/or a Position Detection procedure on the workpiece 100 on the platform 20 above the detection liquid 44. The number of optical sensing devices 80 could be one or plural. Taking plural as an example, a first one of the plurality of optical sensing devices 80 is, for example, set at a position capable of performing optical detection (e.g., adjacent to the detection probe 42), and a second one of the plurality of optical sensing devices 80 is, for example, set at a position capable of performing detection for positioning and anti-collision mechanisms (e.g., above the side of the platform 20 and/or the workpiece 100). Thereby, the first one of the plurality of optical sensing devices 80 and the scanning acoustic microscope 40 respectively correspond to performing the automated optical inspection procedure and/or the ultrasonic scanning detection procedure on the workpiece 100 before and/or after the workpiece 100 attached with the isolation element 50 enters the detection liquid. The second one of the plurality of optical sensing devices 80 respectively performs the position detection procedure on the workpiece 100 and/or the platform 20 before and/or after the workpiece 100 attached with the isolation element 50 enters the detection liquid to provide positioning and anti-collision effects. However, the present disclosure is not limited thereto; the present disclosure could also have a single optical sensing device 80 perform the aforementioned automated optical inspection procedure and/or position detection procedure.

For example, the detection flow of the positioning and anti-collision mechanism of the present disclosure includes, for example but not limited to, the following steps: before the workpiece 100 and the platform 20 enter the detection liquid 44, use the optical sensing device 80 located on the side to perform, for example, image recognition on the workpiece 100 to mark and position each component 120; use the optical sensing device 80 next to the detection probe 42 to perform optical detection of the surface of the measurement area 110 of the workpiece 100; after the surface detection is completed, lower the workpiece 100, the platform 20, and the detection probe 42 below the liquid surface of the detection liquid 44 to perform the ultrasonic scanning detection procedure. During the lowering process of the platform 20 and the detection probe 42, simultaneously use the optical sensing device 80 located on the side to perform detection steps for the positioning and anti-collision mechanism; after the ultrasonic scanning detection procedure is completed, return each component to the initial position.

The optical sensing device 80 of the present disclosure could perform surface optical detection and detection for positioning and anti-collision mechanisms on components 120 located in different media environments (e.g., above and below the liquid surface) in a non-liquid environment (e.g., above the detection liquid 44). However, the optical images sensed by the optical sensing device 80 may have errors due to changes in light incident angle and media environment. Therefore, the present disclosure could optionally further perform an error correction procedure corresponding to the change of the media environment (e.g., non-liquid environment/liquid environment) where the component 120 is located to correct the surface detection results of the automated optical inspection procedure and/or the position detection results of the position detection procedure.

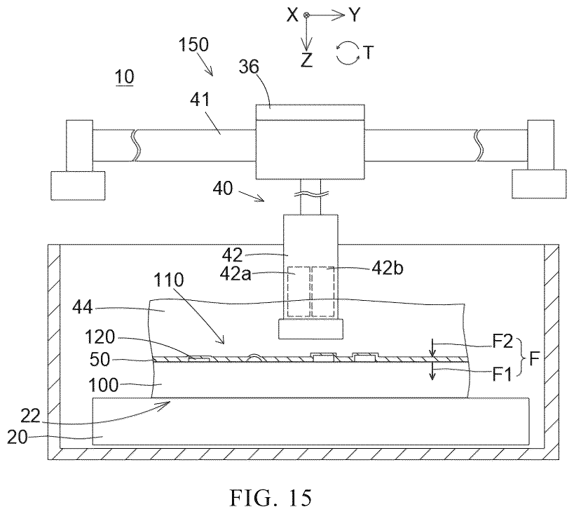

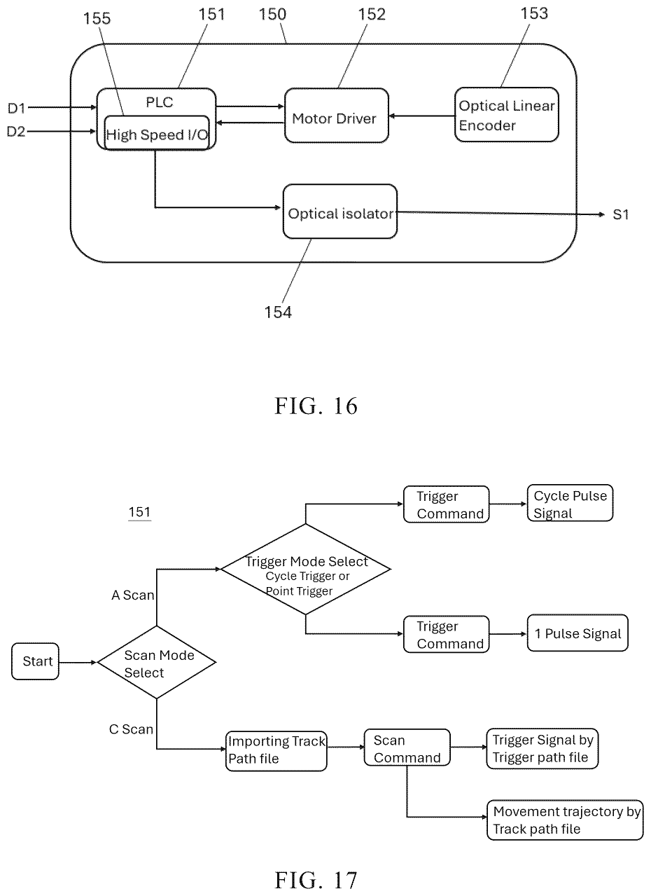

Please refer to FIG. 15, FIG. 16, and FIG. 17, and also refer to FIG. 1 to FIG. 14. The present disclosure further provides an operating system 150 for the scanning acoustic microscope apparatus 10, for operating the aforementioned scanning acoustic microscope 40 having the detection probe 42. The operating system 150 comprises a control element 36. Specifically, the control element 36 of the operating system 150 is configured to: (a) receive or formulate a custom path, the custom path comprising a motion trajectory and a detection timing; and (b) generate a control signal and transmit the control signal to the scanning acoustic microscope 40 to drive the detection probe 42 to perform an ultrasonic scanning detection procedure on the workpiece 100 according to the motion trajectory and detection timing of the custom path.

In a preferred embodiment of the operating system 150 (as shown in FIG. 16), the control element 36 may comprise a Programmable Logic Controller (PLC) 151. The PLC 151 uses, for example, a High Speed I/O module 155 to ensure precise real-time signal processing. The operating system 150 may further comprise a Motor Driver 152 electrically connected to the PLC 151. The operating system 150 may further comprise an Optical Linear Encoder 153 for providing at least one position feedback signal to the PLC 151. In this embodiment, the PLC 151 is configured to receive a track path file D1 defining the motion trajectory, and a trigger path file D2 defining the detection timing, wherein the track path file D1 and the trigger path file D2 are separable and arbitrarily editable. The PLC 151 then controls the Motor Driver 152 according to the track path file D1 containing at least a target position and a target speed, so that the detection probe 42 of the scanning acoustic microscope 40 generates movement corresponding to the motion trajectory. Furthermore, the PLC 151 is configured to output a control signal as a trigger signal S1 when the position feedback signal of the Optical Linear Encoder 153 matches a trigger position defined by the trigger path file D2. The aforementioned target speed is, for example but not limited to, 50 mm/s. The aforementioned track path file D1 and trigger path file D2 are, for example, in binary (. bin) file format.

To ensure signal stability, the operating system 150 of the present disclosure may further comprise an optical isolator 154 set between the PLC 151 and the output port of the trigger signal S1, for isolating and outputting the signal from the PLC 151 as the trigger signal S1.

In one embodiment of the present disclosure, the control element 36 of the operating system 150 (such as the PLC 151 shown in FIG. 16) serves as a central controller (or operating system control element) for planning paths and issuing main commands; and the control element 26 of the adjustment device 24 (such as a motor driver or its controller) serves as a local controller (or platform control element) for receiving commands and executing lifting or tilting of the platform 20. Under this architecture, the control element 36 could transmit signals to the control element 26 for collaborative operation.

However, the present disclosure is not limited thereto. In another embodiment, the functions of the control element 26 could also be integrated into the control element 36, that is, the control element 36 could directly control the operation of the adjustment device 24 via the Motor Driver 152. In this case, the control element 26 of the platform 20 and the control element 36 of the operating system 150 could be regarded as the same control entity.

In addition, as shown in FIG. 17, the PLC 151 could be further configured to receive a Scan Mode Select. When the scan mode selection is a first scan mode (A Scan; Amplitude Scan), a predefined trigger step is executed. The predefined trigger step includes selecting from trigger modes such as a Cycle Trigger or a Point Trigger to output a trigger signal. In some embodiments, the operating system 150 could also be configured to execute a B-Scan (Brightness Scan) scan mode (third scan mode), for example, by continuously acquiring data on a single axial path to form a cross-sectional image. When the scan mode selection is a second scan mode (C Scan; Constant-Depth Scan), the PLC 151 executes the aforementioned steps of receiving the track path file and the trigger path file, controlling the Motor Driver 152, and outputting the trigger signal S1.

The control element 36 (whether broadly configured or specifically implemented as a PLC) could be configured to perform flexible control tasks. For example, the control element 36 could generate control signals and transmit them to a drive mechanism 41 of the scanning acoustic microscope 40, for example, to drive the detection probe 42 to perform the ultrasonic scanning detection procedure on the workpiece 100 according to the aforementioned custom path. The drive mechanism 41 is, for example but not limited to, a multi-axis adjustment element, whereby detection selected from the group consisting of single-axis motion path detection, two-axis motion path detection, three-axis motion path detection, and four-axis motion path detection could be performed. This multi-axis adjustment element is, for example, a four-axis adjustment element comprising an X-axis, a Y-axis, a Z-axis, and a rotation/tilt axis T. The X-axis of the four-axis adjustment element is used for left-right linear movement, the Y-axis is used for front-back linear movement, the Z-axis is used for vertical up-down movement, and the rotation/tilt axis is used for tilt/rotation movement.

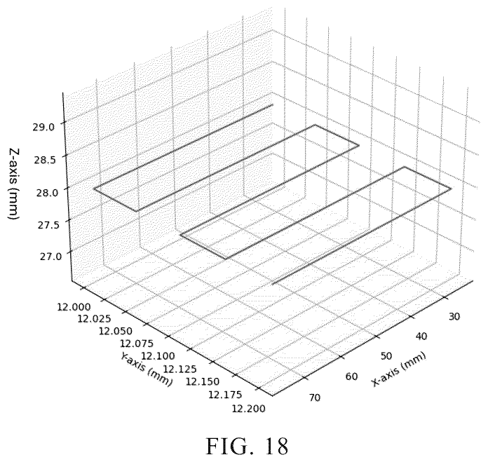

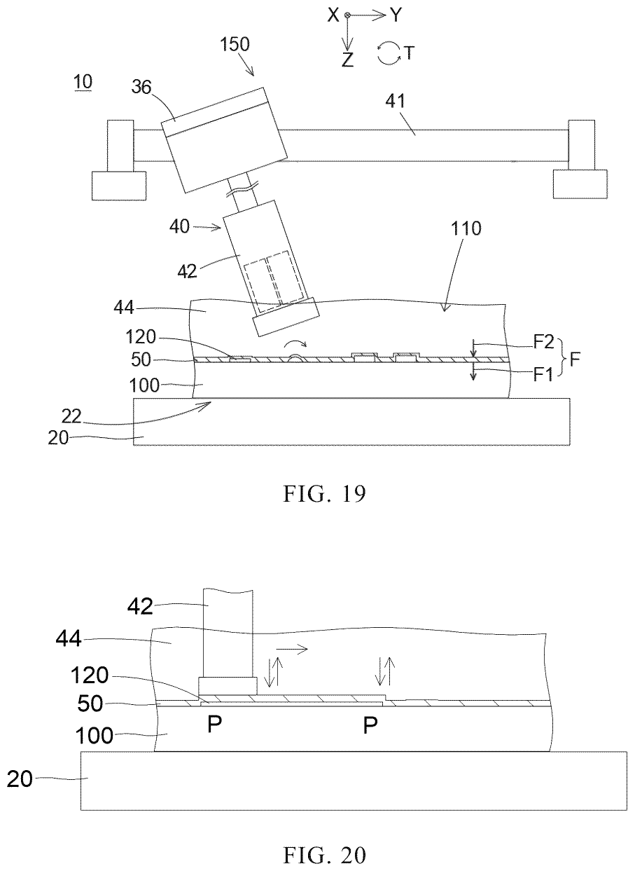

The motion trajectory of the aforementioned custom path may comprise a two-axis motion path. For example, to improve detection efficiency, this two-axis motion path could be defined as selected from the group consisting of a serpentine path (as shown in FIG. 18), a circular path, an S-shaped path, and a square path according to the outer shape of the area to be tested (e.g., measurement area 110) of the workpiece 100 or a region of interest. In addition, the motion trajectory of the aforementioned custom path may also comprise a three-axis motion path. In another embodiment, as shown in FIG. 19, the motion trajectory of the aforementioned custom path may also comprise a four-axis motion path. Specifically, the four-axis motion path could correspond to a curved surface of the workpiece 100, and the four-axis motion path is composed of, for example, a three-axis motion path and a rotation path. When scanning the measurement area 110 of the workpiece 100, the control element 36 is further configured to generate and transmit adjustment signals to the adjustment device of the scanning acoustic microscope 40 (e.g., drive mechanism 41) and/or the control element 26 of the adjustment device 24 of the platform 20 (as shown in FIG. 8). Specifically, in some embodiments, the control element 36 of the operating system 150 could transmit the adjustment signal to the control element 26 of the platform 20, and the adjustment signal contains a set of control data for dynamically compensating a height and/or a tilt angle of the measurement area 110 (e.g., curved surface) of the workpiece 100. The control element 26 then drives the adjustment device 24 accordingly, thereby cooperating with the detection probe 42 to scan along the measurement area 110 (e.g., curved surface) of the workpiece 100, and optionally dynamically adjusting the height and/or tilt angle of the measurement area 110 (e.g., curved surface) of the workpiece 100, to ensure that the detection probe 42 constantly maintains an optimal focal length.

In the operation of the scanning acoustic microscope, a common scanning method is Continuous Scan, or Raster Scan. In this mode, the control element 36 controls the detection probe 42 to move continuously at a constant speed along a main axis (e.g., X-axis), and continuously transmits and receives ultrasonic signals to acquire data during the movement. After the detection probe 42 completes scanning a whole line, it steps over a tiny fixed distance on another perpendicular axis (e.g., Y-axis), and then scans the next line along the X-axis. This action of acquiring (continuously) along one axis and stepping on another axis is repeated continuously until the detection probe 42 completely scans the entire preset target area, finally combining into a high-resolution two-dimensional planar image (e.g., C-Scan image).

In addition, as another embodiment of the custom path, the control element 36 could also control the detection probe 42 (as shown in FIG. 1 to FIG. 15 and FIG. 19) to perform detection in a stamp method (step-and-repeat). This custom path comprises a plurality of discrete measurement points P (as shown in FIG. 20), and the control element 36 controls the detection probe 42 to move between these measurement points P (as indicated by arrows in FIG. 20) and perform detection. For example, in a scanning acoustic microscope, the stamp method (or point-to-point and step-and-repeat scan) is a non-continuous detection mode. Its specific process is: the control element 36 drives the detection probe 42 to precisely move to a first preset discrete measurement point P, then stops completely; next, the detection probe 42 performs, for example, a complete ultrasonic measurement (e.g., acquiring one A-Scan waveform) in a stationary state. After the data acquisition of this discrete measurement point P is completed, the detection probe 42 moves to the next discrete measurement point P, and repeats this “move, stop, detect” cycle, sequentially completing scanning of all specified measurement points P.

Regarding the acquisition method of the custom path, there are several embodiments. In one embodiment, the control element 36 is configured to use the optical sensing device 80 and/or the detection probe 42 to perform an autofocus or surface ranging procedure on the workpiece 100 to acquire a three-dimensional profile of the area to be tested (e.g., measurement area 110) of the workpiece 100, and generate the custom path according to the three-dimensional profile.

In another embodiment, especially when attached to the aforementioned implementation of PLC 151, the control element 36 determines the track path file and trigger path file it is to receive by loading a predefined task setting (also called a Recipe), and thereby determines the custom path.

To further improve detection quality, the control element 36 is further configured to dynamically adjust the moving speed of the detection probe 42 or the platform 20 according to a relative position (e.g., distance) between the detection probe 42 and the workpiece 100 during the execution of the ultrasonic scanning detection procedure. For example, the moving speed is reduced when the detection probe 42 is close to the workpiece 100 to reduce vibration interference. For example, the moving speed of the detection probe 42 or the platform 20 is inversely proportional to the distance between the detection probe 42 and the workpiece 100.

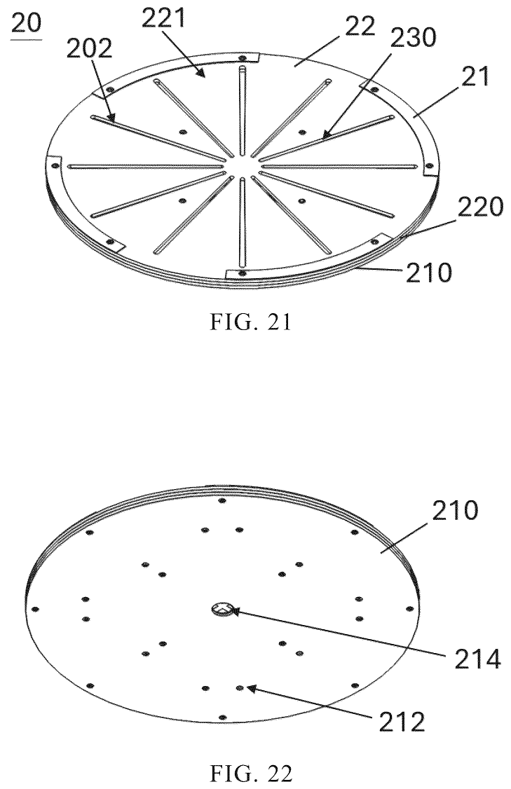

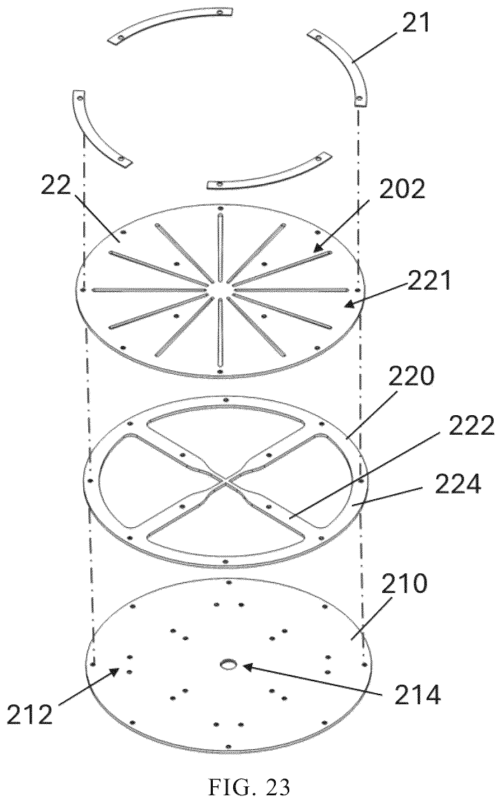

The platform 20 disclosed in FIG. 1 to FIG. 20 of the present disclosure could also be, for example but not limited to, a fluid-flow type adsorption platform suitable for operation in the environment of the detection liquid 44. The fluid-flow type adsorption platform of the present disclosure could fix the workpiece 100 without using mechanical clamps and could adjust the suction force, so it could solve the problems of uneven fixation by conventional mechanical clamps or causing warpage of the workpiece. Specifically, referring to FIG. 21, the platform 20 of the present disclosure comprises a placing stage 22, a base 210, and a spacer frame 220, wherein the spacer frame 220 is provided between the placing stage 22 and the base 210. The placing stage 22 has a carrying surface 221 for carrying the workpiece 100, and the placing stage 22 is provided with at least one fluid channel 202 penetrating the carrying surface 221. The spacer frame 220 could form a chamber 230 between the placing stage 22 and the base 210. The placing stage 22, the base 210, and/or the spacer frame 220 could be made by, for example but not limited to, laser cutting, 3D printing, or injection molding. The spacer frame 220 includes, for example but not limited to, an annular frame 224 and ribs 222, the ribs 222 being connected inside the annular frame 224, and are for example cross-shaped ribs. The placing stage 22, the base 210, and the spacer frame 220 could be detachably combined together, for example by screwing or other methods, or fixedly connected together.

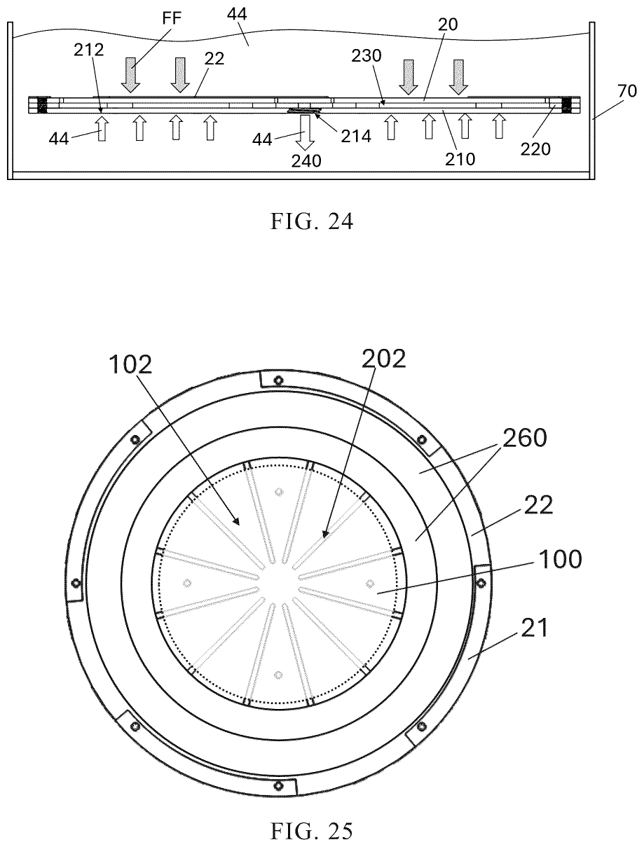

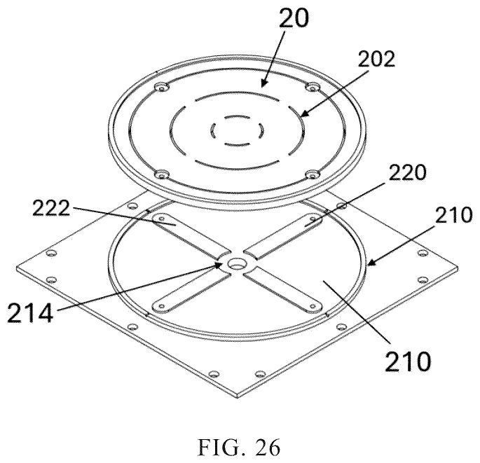

The base 210 is provided with at least one inlet 212 and at least one outlet 214 communicating with the chamber 230. The platform 20 may further comprise a pump 240. When the platform 20 is immersed in the detection liquid 44 of the processing tank 70, the pump 240 could draw the detection liquid 44 out of the chamber 230 via the outlet 214, and thereby draw the detection liquid 44 in the processing tank 70 into the chamber 230 via the inlet 212, so that the detection liquid 44 forms a continuous flow in the chamber 230. This continuous flow generates a negative pressure at the fluid channel 202 of the placing stage 22, and forms a suction force FF (as shown in FIG. 24) for adsorbing the workpiece 100 by the negative pressure.

To adapt to workpieces 100 of different sizes, the platform 20 of the present disclosure can, for example but not limited to, comprise a mechanism for defining an effective adsorption area. Referring to FIG. 25, in a feasible aspect, the platform 20 may further comprise at least one blocking piece 260. The blocking piece 260 (e.g., concentric rings with different inner diameters) could be correspondingly disposed on the carrying surface 221 of the placing stage 22 according to the size of the workpiece 100 to shield a part of the fluid channels 202, thereby defining an effective adsorption area 102 corresponding to the size of the workpiece 100.

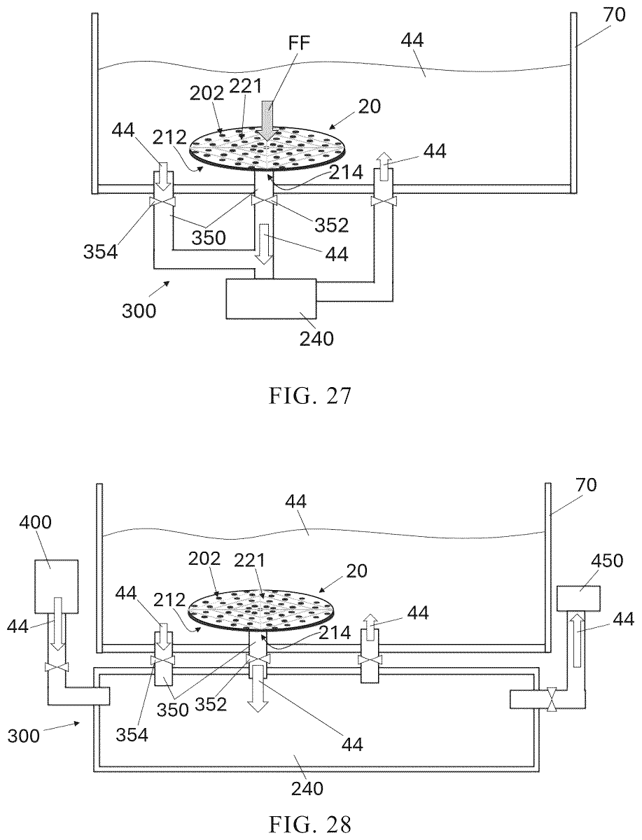

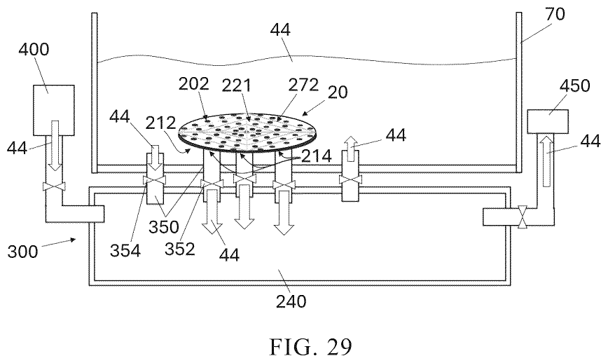

To realize adjustable suction force and solve the risk in the prior art that the pump might run dry due to channel blockage, as shown in FIG. 27, FIG. 28, and FIG. 29, the platform 20 of the present disclosure may further comprise a regulation device 300. The regulation device 300 adjusts the magnitude of the negative pressure by regulating the inflow rate of the detection liquid 44 from the inlet 212 and the outflow rate from the outlet 214, thereby controlling the magnitude of the suction force formed by the negative pressure. The regulation device 300 comprises, for example, a Y-shaped pipe 350. A first end of the Y-shaped pipe 350 (e.g., provided with a main valve 352) is connected to the chamber 230 to constitute the outlet 214, a second end of the Y-shaped pipe 350 (e.g., provided with a pressure-dividing valve 354) directly communicates with the processing tank 70, and a third end of the Y-shaped pipe 350 is connected to the pump 240. The regulation device 300 of the present disclosure could control the magnitude of the negative pressure by adjusting the opening degree of the pressure-dividing valve 354, that is, adjusting the magnitude of the suction force formed by the negative pressure. The present disclosure could not only ensure that the pump 240 always has fluid passing through by the second end of the Y-shaped pipe 350 to prevent dry running, but could also precisely regulate the suction force magnitude to avoid deformation of thin workpieces 100 due to excessive adsorption force. Although FIG. 28 and FIG. 29 only illustrate two main pipes and pressure-dividing pipes respectively having a main valve 352 and a pressure-dividing valve 354, since these two main pipes and pressure-dividing pipes are both connected to the pump 240, their operation principle is the same as that of the Y-shaped pipe.

In addition, the present disclosure further exerts an integrated water exchange function, as shown in FIG. 28 and FIG. 29, wherein the detection liquid 44 drawn out via the pump 240 could be further selectively transported into the processing tank 70 via piping with valves (not numbered) of the regulation device 300 to provide a circulation effect, or be discharged to a drainage port 450 outside the processing tank 70. Furthermore, the detection liquid 44 in the processing tank 70 could also come from an external facility supply source 400. For example, the present disclosure uses piping with valves (not numbered) to communicate the pump 240 with the external facility supply source 400, whereby the detection liquid 44 could be added to the processing tank 70 via the operation of the pump 240. In other words, in the present disclosure, the detection liquid 44 drawn into the chamber 230 from the inlet 212 could come from an external facility supply source 400.

In addition, refer to FIG. 29, the number of outlets 214 could be plural, and the plurality of outlets 214 are distributed on the base 210. In this aspect, the platform 20 may further comprise a multi-channel piping network 272 for respectively communicating with one or more of the plurality of outlets 214, and a plurality of control valves (e.g., main valves 352) respectively connected to different areas of the multi-channel piping network 272. Thereby, the control element 36 (or control element 26) could independently control the opening and closing of these control valves to perform zoned adsorption control on the carrying surface 221 of the placing stage 22. These control valves are, for example but not limited to, solenoid valves.

In some embodiments, the platform 20 may optionally further comprise at least one limiting member 21 disposed on the placing stage 22 (as shown in FIG. 23) for fixing the position of the workpiece 100. The positioning area of the limiting member 21 could be of a fixed design or an adjustable design, whereby the size of the positioning area could be correspondingly adjusted according to the size of the workpiece 100. The limiting member 21 could be detachably combined on the placing stage 22, for example by screwing or other methods, or fixedly connected on the placing stage 22. Moreover, the present disclosure could also optionally use, for example, the aforementioned blocking piece 260 (as shown in FIG. 25) to replace the limiting member 21.

In other embodiments, the placing stage 22, spacer frame 220, and base 210 of the platform 20 could also be integrally formed. In addition, the platform 20 of this embodiment could also be disposed on the aforementioned adjustment device 24 (as shown in FIG. 8), wherein the adjustment device 24 is, for example, a multi-axis adjustment element, such as but not limited to a four-axis adjustment element, whereby various aforementioned adjustments could be performed on the carrying surface 221 of the placing stage 22.

The platform 20 of the present disclosure could provide a controllable, uniform, and non-obscuring adsorption force in a liquid environment. Since this fluid adsorption force is uniformly distributed on the surface of the workpiece, it could avoid stress concentration caused by traditional mechanical clamps, effectively reduce deformation or warpage generated by thin or fragile workpieces (such as wafers) during the adsorption process, and stably hold workpieces with slightly uneven surfaces. This characteristic makes it particularly suitable as a platform for workpiece in scanning acoustic microscopes.

In summary, the scanning acoustic microscope apparatus and its operating system and platform of the present disclosure have the following advantages:
(1) Using an isolation element with a waterproof effect to wrap the workpiece, detection probe, and/or detection liquid could create an isolation effect between the workpiece (e.g., electronic component) and the detection liquid (e.g., water).
(2) The thickness of the isolation element does not affect ultrasonic transmission, the acoustic impedance of the isolation element is substantially similar to or the same as that of the detection liquid, and it could be closely or conformally attached to the surface of the measurement area of the workpiece.
(3) Using the isolation element to block contact between the workpiece and the detection liquid could effectively solve the problem that electronic components are not suitable for contacting detection liquid, and at the same time could avoid the problem of performing drying processes that are time-consuming or have a high risk of thermal damage.
(4) The platform combined with the adjustment device could provide functions such as lifting, turning, translation, tilt adjustment, flatness adjustment, and/or straightness adjustment.
(5) The adjustment device could suspend the platform and the workpiece carried by it in the detection liquid by hanging or raising. In addition, the control element of the present disclosure could be located outside the liquid surface, eliminating the need to increase the waterproof rating requirement while still being able to fully control the adjustment of the platform, planning of scanning paths, and execution of detection procedures.
(6) The platform is formed by splicing or assembling multiple combined expansion stages, thereby being adaptable to different sizes of processing tanks, and only needs to make the measurement area have high precision flatness without needing every part to have high precision flatness to perform the ultrasonic scanning detection procedure.
(7) By combining the technologies of the optical sensing device and the scanning acoustic microscope, surface detection procedures of automated optical inspection and ultrasonic scanning detection procedures could be performed above and below the liquid surface respectively, and positioning and anti-collision functions could be provided.
(8) The operating system of the present disclosure could flexibly perform scanning of single-axis, two-axis, three-axis, or four-axis motion paths on the workpiece through custom paths.

(9) The fluid-flow type adsorption platform of the present disclosure could provide stable and controllable negative pressure suction in a detection liquid environment to firmly hold the workpiece on the platform, and by ensuring constant fluid passage, effectively solve the risk of pump dry running and damage in the prior art, improving detection stability.

(10) The fluid-flow type adsorption platform of the present disclosure, by providing uniform and gentle adsorption force (e.g., suction force) through fluid negative pressure, could effectively adsorb workpieces (e.g., objects to be tested) with slightly uneven or warped surfaces, and could significantly reduce deformation or damage caused by adsorption stress in thin workpieces.

It should be understood that the specific details of elements, modules, or steps not explicitly described in this specification could be implemented using conventional techniques in the field. Those of ordinary skill in the art to which the present disclosure pertains should understand that when implementing the core inventions mentioned in the present disclosure (such as the isolation element, operating system, and platform), their associated non-core auxiliary equipment, specific operating parameters, or software implementation details, if not specifically limited, could be implemented with reference to common general knowledge or conventional techniques in the field. For example, regarding the operating system 150, its specific software programming language, the specific model of the PLC 151, or the specifications of the Motor Driver 152 and corresponding motors; regarding the platform 20, its specific pump 240 model, piping materials, or forms of valves 352, 354; and regarding the isolation element 50, its specific polymer formula or molding method (e.g., other conventional manufacturing methods other than laser cutting, 3D printing, or injection molding disclosed in this case), if not specifically limited, could be implemented with reference to common general knowledge in the field. All such various equivalent changes or modifications do not depart from the scope intended to be protected by the present disclosure. The above description is illustrative only and not restrictive. Any equivalent modifications or changes made without departing from the spirit and scope of the present disclosure shall be included in the appended claims.

What is claimed is:

1. A scanning acoustic microscope (SAM) apparatus, comprising:
a platform configured to carry at least one workpiece;
a scanning acoustic microscope having a detection probe; and
at least one isolation element configured to cause an isolation state between the workpiece and a detection liquid,
wherein the scanning acoustic microscope provides ultrasonic waves via the detection probe that penetrate the detection liquid and the at least one isolation element attached to the workpiece, thereby performing an ultrasonic scanning detection procedure on the workpiece on the platform.

2. The SAM apparatus of claim 1, wherein the isolation element is a bag body, the detection liquid is filled in the bag body to provide a liquid environment, the detection probe is immersed in the detection liquid in the bag body, and the bag body is attached to the workpiece with an outer surface, wherein the workpiece is located in a non-liquid environment.

3. The SAM apparatus of claim 2, further comprising a fixing utensil provided on the isolation element, wherein the fixing utensil fixes the isolation element to at least one end portion of the detection probe, or expands the isolation element into the liquid environment filled with the detection liquid, thereby allowing the detection probe to be movably located in the liquid environment.

4. The SAM apparatus of claim 1, wherein the isolation element is a bag body, the workpiece is wrapped inside the bag body in a non-liquid environment, such that the bag body is attached to the workpiece with an inner surface, wherein the detection probe is located outside the bag body and in a liquid environment provided by the detection liquid.

5. The SAM apparatus of claim 4, further comprising a processing tank, wherein the detection liquid is located in the processing tank to provide the liquid environment, and the workpiece is immersed in the detection liquid in the processing tank under protection of the isolation element, causing the isolation state between the workpiece and the detection liquid.

6. The SAM apparatus of claim 1, wherein the isolation element is attached to all or a part of the workpiece by an external force.

7. The SAM apparatus of claim 6, further comprising an external force supply source, wherein the external force supply source is an air extraction device for providing a suction force as the external force, and the air extraction device causes the isolation element to closely or conformally attach to the workpiece by extracting a gas between the isolation element and the workpiece.

8. The SAM apparatus of claim 6, further comprising an external force supply source, wherein the external force supply source is a pushing force source for providing a pushing force as the external force, and the pushing force source causes the isolation element to closely or conformally attach to the workpiece by applying the external force.

9. The SAM apparatus of claim 1, wherein an acoustic impedance of the isolation element is approximately equal to or the same as an acoustic impedance of the detection liquid.

10. The SAM apparatus of claim 1, wherein the isolation element has a deformable structure.

11. The SAM apparatus of claim 1, wherein the isolation element comprises an elastic material and/or a stretchable material.

12. The SAM apparatus of claim 1, wherein a material of the isolation element is selected from the group consisting of polymers composed of silicone, rubber, plastic, and composite high-polymer polymers.

13. The SAM apparatus of claim 1, wherein the platform comprises at least one placing stage for carrying the workpiece.

14. The SAM apparatus of claim 13, wherein the platform comprises at least one adjustment device for adjusting a height and/or a tilt angle of at least one side of the workpiece on the placing stage.

15. The SAM apparatus of claim 14, wherein the adjustment device of the platform comprises at least one control element for controlling, outside the detection liquid, the adjustment device to adjust the height and/or the tilt angle of the at least one side of the workpiece on the placing stage.

16. The SAM apparatus of claim 13, further comprising at least one processing tank, wherein the platform is located in the processing tank for carrying the workpiece, wherein the detection liquid is filled in the processing tank to provide a liquid environment.

17. The SAM apparatus of claim 14, wherein the placing stage of the platform is suspended in the detection liquid by hanging or raising by means of the adjustment device.

18. The SAM apparatus of claim 16, wherein the platform comprises a plurality of combined expansion stages, wherein one or more of the plurality of combined expansion stages constitute the placing stage of the platform, thereby adjusting a size of the platform according to a size of the processing tank.

19. The SAM apparatus of claim 18, wherein a flatness of at least one first area of the platform is better than a flatness of at least one second area, and the first area corresponds to the placing stage and/or a measurement area of the workpiece set on the placing stage.

20. The SAM apparatus of claim 1, further comprising at least one optical sensing device for performing an automated optical inspection procedure and/or a position detection procedure on the workpiece on the platform above the detection liquid.

21. The SAM apparatus of claim 20, wherein the optical sensing device and the scanning acoustic microscope respectively perform the automated optical inspection procedure and/or the ultrasonic scanning detection procedure on the workpiece correspondingly before and/or after the workpiece attached with the isolation element enters the detection liquid.

22. The SAM apparatus of claim 20, wherein the optical sensing device performs the position detection procedure on the workpiece and/or the platform before and/or after the workpiece attached with the isolation element enters the detection liquid.

23. The SAM apparatus of claim 22, wherein the optical sensing device performs an error correction procedure according to a change in a media environment where the workpiece and/or the platform is located to correct a surface detection result of the automated optical inspection procedure and/or a position detection result of the position detection procedure.

24. The SAM apparatus of claim 1, wherein the detection probe of the scanning acoustic microscope has an ultrasonic transmitter for outputting the ultrasonic waves and an ultrasonic receiver for receiving the ultrasonic waves, and the ultrasonic transmitter and the ultrasonic receiver are respectively located on the same side or different sides of the workpiece.

25. The SAM apparatus of claim 1, wherein the scanning acoustic microscope further comprises an operating system having a control element, the control element is used to control the detection probe to perform the ultrasonic scanning detection procedure on the workpiece according to a custom path, and the custom path comprises a track path and a detection timing.

26. The SAM apparatus of claim 25, wherein the custom path is selected from the group consisting of a single-axis motion path, a two-axis motion path, a three-axis motion path, and a four-axis motion path.

27. The SAM apparatus of claim 26, wherein the two-axis motion path is selected from the group consisting of a serpentine path, a circular path, an S-shaped path, and a square path.

28. The SAM apparatus of claim 26, wherein the four-axis motion path corresponds to a curved surface of the workpiece.

29. The SAM apparatus of claim 28, wherein the control element is further used to control the detection probe to rotate to correspond to a normal direction of the curved surface in the ultrasonic scanning detection procedure.

30. The SAM apparatus of claim 25, wherein the custom path comprises a plurality of discrete measurement points, and the control element controls the detection probe to move between the plurality of measurement points in a stamp method and perform detection.

31. The SAM apparatus of claim 25, wherein the control element is further used to dynamically adjust a moving speed of the detection probe according to a relative position between the detection probe and the workpiece when executing the ultrasonic scanning detection procedure, and reduce the moving speed when the detection probe is close to the workpiece to reduce vibration interference.

32. The SAM apparatus of claim 25, wherein the control element determines the custom path by loading a predefined task setting.

33. The SAM apparatus of claim 25, wherein the control element uses an optical sensing device and/or the detection probe to perform an autofocus or surface ranging procedure on the workpiece to acquire a three-dimensional profile of an area to be tested of the workpiece, and generates the custom path according to the three-dimensional profile.

34. The SAM apparatus of claim 25, wherein the control element is configured to generate and transmit an adjustment signal to a drive mechanism for cooperating with the detection probe to scan along a curved surface of the workpiece, and dynamically adjust a height and/or a tilt angle of at least one side of the workpiece.

35. An operating system for a scanning acoustic microscope, for operating a scanning acoustic microscope having a detection probe, the operating system comprising: a control element configured to: (a) receive or formulate a custom path, the custom path comprising a motion trajectory and a detection timing; and (b) generate a control signal and transmit the control signal to the scanning acoustic microscope to drive the detection probe to perform an ultrasonic scanning detection procedure on a workpiece according to the motion trajectory and the detection timing of the custom path.

36. The operating system of claim 35, wherein the control element comprises a Programmable Logic Controller (PLC), and the operating system further comprises:
a Motor Driver electrically connected to the PLC; and
an Optical Linear Encoder for providing a position feedback signal to the PLC, wherein the PLC is configured to:
receive a track path file defining the motion trajectory and a trigger path file defining the detection timing, wherein the track path file and the trigger path file are separable and arbitrarily editable;
control the Motor Driver according to the track path file containing at least a target position and a target speed, so that the scanning acoustic microscope generates movement corresponding to the motion trajectory of the track path file; and
output the control signal as a trigger signal when the position feedback signal of the Optical Linear Encoder matches a trigger position defined by the trigger path file.

37. The operating system of claim 36, further comprising an optical isolator disposed between the PLC and an output port of the trigger signal for isolating and outputting a signal from the PLC as the trigger signal.

38. The operating system of claim 36, wherein the PLC is further configured to: receive a scan mode selection; wherein when the scan mode selection is a first scan mode (A Scan), a predefined trigger step is executed, the predefined trigger step comprises selecting from a Cycle Trigger or a Point Trigger to output the trigger signal; wherein when the scan mode selection is a second scan mode (C Scan), the steps of receiving the track path file and the trigger path file, controlling the Motor Driver, and outputting the trigger signal as described in claim 36 are executed.

39. The operating system of claim 35, wherein the custom path is selected from the group consisting of a single-axis motion path, a two-axis motion path, a three-axis motion path, and a four-axis motion path.

40. The operating system of claim 39, wherein the two-axis motion path is selected from the group consisting of a serpentine path, a circular path, an S-shaped path, and a square path.

41. The operating system of claim 39, wherein the four-axis motion path corresponds to a curved surface of the workpiece.

42. The operating system of claim 36, wherein the control element determines the track path file and the trigger path file to be received by loading a predefined task setting.

43. The operating system of claim 35, wherein the control element is configured to use an optical sensing device and/or the detection probe to perform an autofocus or surface ranging procedure on the workpiece to acquire a three-dimensional profile of an area to be tested of the workpiece, and generate the custom path according to the three-dimensional profile.

44. The operating system of claim 35, wherein the control element is further configured to dynamically adjust a moving speed of the detection probe or a platform according to a relative position between the detection probe and the workpiece when executing the ultrasonic scanning detection procedure, and reduce the moving speed when the detection probe is close to the workpiece to reduce vibration interference.

45. The operating system of claim 35, wherein the custom path corresponds to a curved surface of the workpiece, and the control element is further configured to generate and transmit an adjustment signal to an adjustment device of the scanning acoustic microscope, the adjustment signal containing a set of control data for dynamically compensating a height and/or a tilt angle of the workpiece.

46. A platform, comprising:
a placing stage having a carrying surface for carrying a workpiece, wherein the placing stage is provided with at least one fluid channel penetrating the carrying surface; and
a base, wherein a chamber is formed between the base and the placing stage, and the base is provided with at least one inlet and at least one outlet communicating with the chamber,
wherein a detection liquid flows from the inlet of the base through the chamber and flows out from the outlet of the base to form a continuous flow in the chamber, thereby generating a negative pressure at the fluid channel of the placing stage, and forming a suction force for adsorbing the workpiece by the negative pressure.

47. The platform of claim 46, further comprising a spacer frame disposed between the placing stage and the base, thereby forming the chamber between the placing stage and the base.

48. The platform of claim 46, further comprising a regulation device for adjusting a magnitude of the negative pressure, thereby controlling the suction force formed by the negative pressure.

49. The platform of claim 48, wherein the regulation device adjusts the magnitude of the negative pressure by regulating an inflow rate of the detection liquid from the inlet and an outflow rate from the outlet, thereby controlling a magnitude of the suction force formed by the negative pressure.

50. The platform of claim 46, further comprising a processing tank for containing the detection liquid, wherein the placing stage and the base are immersed in the detection liquid of the processing tank when in use.

51. The platform of claim 50, further comprising a pump for drawing the detection liquid out of the chamber via the outlet of the base, and thereby drawing the detection liquid in the processing tank into the chamber via the inlet of the base to form the continuous flow in the chamber.

52. The platform of claim 51, wherein the pump is connected to a third end of a Y-shaped pipe, a first end of the Y-shaped pipe is connected to the chamber to constitute the outlet, and a second end of the Y-shaped pipe communicates with the processing tank.

53. The platform of claim 52, further comprising a main valve and a pressure-dividing valve, the main valve being disposed on the first end of the Y-shaped pipe, and the pressure-dividing valve being disposed on the second end of the Y-shaped pipe, wherein a magnitude of the negative pressure is controlled by adjusting an opening degree of the pressure-dividing valve, thereby controlling a magnitude of the suction force formed by the negative pressure.

54. The platform of claim 53, wherein the detection liquid drawn into the chamber via the inlet comes from an external facility supply source, or a source of the detection liquid contained in the processing tank is an external facility supply source.

55. The platform of claim 53, wherein the detection liquid drawn out by the pump is selectively transported into the processing tank or discharged to a drainage port outside the processing tank.

56. The platform of claim 46, further comprising at least one limiting member disposed on the placing stage for fixing a position of the workpiece carried by the placing stage.

57. The platform of claim 46, wherein the placing stage and the base are integrally formed.

58. The platform of claim 46, further comprising an adjustment element, wherein the placing stage adjusts the carrying surface of the placing stage by means of the adjustment element.

59. The platform of claim 46, wherein a quantity of the outlet is plural, the plurality of outlets are distributed on the base, and the platform further comprises: a multi-channel piping network for communicating with the plurality of outlets; and a plurality of control valves respectively connected to different areas of the multi-channel piping network for performing zoned adsorption control on the carrying surface of the placing stage.

60. The platform of claim 46, further comprising at least one blocking piece disposed on the carrying surface of the placing stage for shielding a part of the fluid channel, thereby defining an effective adsorption area corresponding to a size of the workpiece.

61. The platform of claim 46, wherein the placing stage and/or the base are made by laser cutting, 3D printing, or injection molding.

62. The platform of claim 46, wherein the workpiece is a workpiece by a Scanning Acoustic Microscope (SAM).

63. The platform of claim 46, wherein the detection liquid is an aqueous solution.
